(19) United States
(12) Patent Application Publication
(10) Pub. No.: US 2006/0234618 A1
(43) Pub. Date: Oct. 19, 2006

(54) Gambrel systems

(76) Inventors: Kevin Alexander Koch, Ashland, IL (US); Laverne Maxwell, Rushville, IL (US)

Correspondence Address: CARGILL, INCORPORATED, LAW/24, 15407 MCGINTY ROAD WEST, WAYZATA, MN, 55391, US

(21) Appl. No.: 11/110,479

(22) Filed: Apr. 20, 2005

Related U.S. Application Data
(60) Provisional application No. 60/664,720, filed on Mar. 23, 2005.

(51) Int. Cl. A22B 7/00

(52) U.S. Cl. 452/189

(57) ABSTRACT

Gambrel systems are provided for hanging and transporting animal carcasses. For example, a gambrel includes an elongated member having a retaining portion, e.g., a notch or other means, adjacent each end of the elongated member to prevent a leg of the carcass from slipping off of the end when the gambrel is tilted from the horizontal.

### CROSS-REFERENCE TO RELATED APPLICATIONS

This application claims the benefit of prior U.S. Provisional Application No. 60/664,720, filed Mar. 23, 2005, which is incorporated herein by reference in its entirety.

### TECHNICAL FIELD

This invention relates to gambrel systems, and more particularly to gambrel sticks for hanging carcasses, e.g., hog carcasses.

### BACKGROUND

During commercial meat production in a slaughterhouse, a carcass is subjected to a number of different procedures. An animal is first stunned and bled, and the resulting carcass is then subjected to further processing. Throughout this specification, the term “carcass” will be used to refer to the animal body after the animal is stunned and bled. The animal carcass is typically split into two equal halves at some point along the processing line depending on its species and the intended purpose for the carcass.

During commercial meat production, the carcass may be attached to a gambrel (a horizontal supporting bar), e.g., through incisions in the hind feet of the animal, at an early point along the meat processing line. The carcass hangs from the gambrel, head toward the floor, allowing it to be moved along the meat processing line, e.g., by a power chain.

A number of processing functions are performed on the carcass at various work stations along the processing line. One such processing step is splitting of the carcass into nearly equal halves along the backbone, generally leaving a lower portion of the carcass unsplit. In some cases, for example if the entire length of the carcass is split, one or both of the hind legs may slide off of the gambrel. This may create an unsanitary condition, and makes it difficult or impossible to re-hang the carcass.

Some attempts have been made to secure an animal's legs to a gambrel. For example, U.S. Pat. No. 5,071,389 describes a folding gambrel having a pair of prongs at each end, each leg being secured between the two prongs.

### SUMMARY

The present invention provides gambrels for securely holding the legs of an animal carcass even if the entire length of the carcass is split, separating the carcass into halves.

In one aspect, the invention features a gambrel for hanging an animal carcass, the gambrel including (a) an elongated member having a first end, a second end, and a central region intermediate the ends, (b) between each end and the central region, a curved portion for receiving a leg of the animal carcass, and (c) adjacent each end, a retaining portion having an edge that engages the leg and prevents the leg from sliding off of the end when the elongated member is tilted from a horizontal position.

The retaining portion may include a notch indented into an upper surface of the elongated member defining a hook. The edge may extend widthwise across the upper surface at an upper end of the notch, and is sufficiently deep so as to receive a tendon of the animal carcass. The elongated member may be a single, unitary rigid member. The elongated member may be constructed to suspend a hog carcass. The gambrel may also include, adjacent an inner end of each curved portion, a protrusion that extends outwardly from the elongated member to prevent the leg from sliding into the central region when the elongated member is tilted from a horizontal position.

In another aspect, the invention features a gambrel for suspending an animal carcass, including (a) a support means for supporting the weight of the animal carcass, the support means including means for receiving first and second legs of the animal carcass, (b) a first means for preventing the first leg of the animal carcass from slipping from the support means when the support means is tilted; and (c) a second means for preventing the second leg of the animal carcass from slipping from the support means when the support means is tilted.

The invention also features methods of using such gambrels.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a gambrel.

FIG. 2 is an enlarged detail view of the circled area of FIG. 1.

FIGS. 3 and 4 are front and back views of the gambrel.

FIG. 5 is a top view of the gambrel.

FIG. 6 is a perspective view of a portion of a hog carcass hanging from the gambrel of FIG. 1.

Like reference symbols in the various drawings indicate like elements.

### DETAILED DESCRIPTION

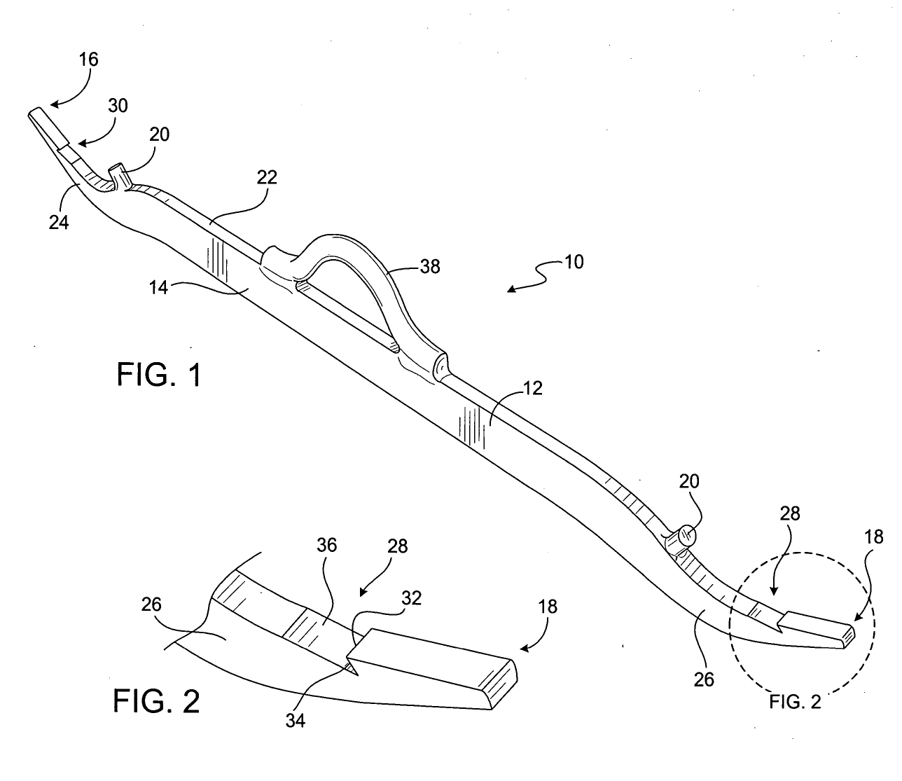

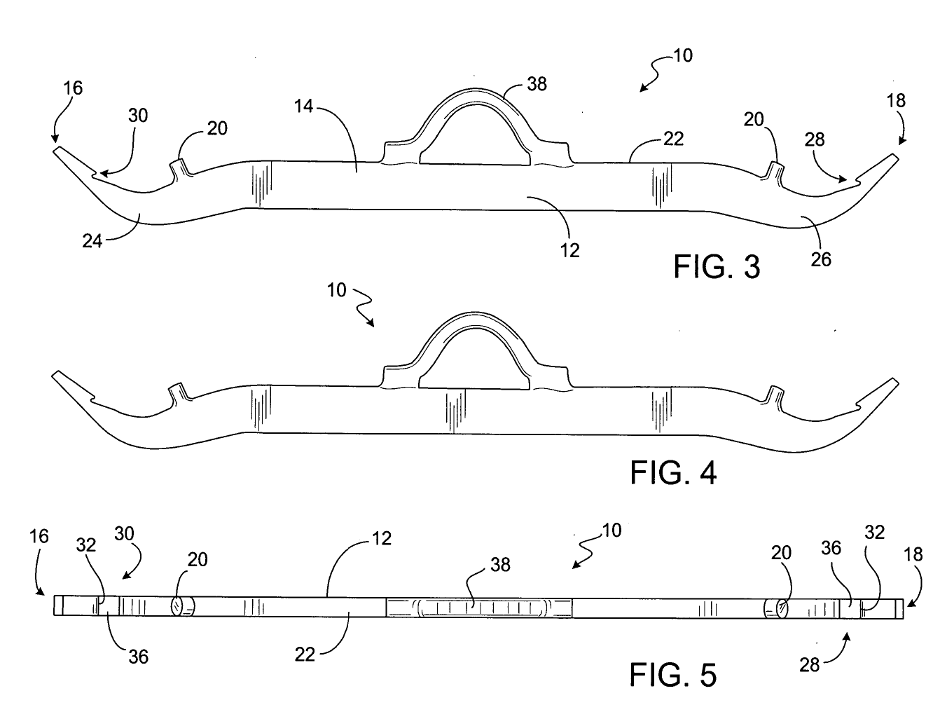

Referring to FIG. 1, gambrel 10 includes an elongated member 12 having a central region 14, and two ends 16, 18. A pair of protrusions 20 extend from an upper surface 22 of the elongated member. Protrusions 20 are preferably at least 0.3 inches high, measured from the upper surface 22, e.g., about 0.375 to 0.625 inches high. Between the protrusions 20 and the ends 16, 18, lie curved areas 24, 26. The curved areas generally have a radius of curvature of about 1.5 to 2.5 inches, preferably about 1.75 to 2.25 inches.

A pair of notches 28, 30 extend into the upper surface 22 at the outer end of the curved areas, adjacent the ends 16, 18 (for example, within 1-3 inches of the ends). Referring to FIG. 2, each notch includes a relatively sharp edge 32, an angled upper wall 34, and a lower wall 36. The angle between upper wall 34 and lower wall 36 is generally about 30 to 60 degrees, e.g., about 40 to 50 degrees. Edge 32 is preferably sharp enough to positively engage a tendon of an animal carcass when the hind foot of the animal carcass slides towards it. The depth of the notch, i.e., the distance between edge 32 and surface 36, measured normal to surface 36, will depend on the type of carcass to be secured. For a hog carcass, the distance may be, for example, about 0.15 to 0.3 inch.

Gambrel 10 also includes a hanger 38 for suspending the gambrel. It is generally preferred that hanger 38 be dimensioned and shaped to allow the gambrel to be easily hung in a meat processing facility and moved along a meat processing line. If the gambrel is to be used to hang a hog carcass, it is generally preferred that the gambrel have a total length, measured along the horizontal, of about 20 to 25 inches, e.g., about 21 to 23 inches.

Gambrel 10 is generally formed as a single, integral piece, from a rigid material such as metal, for example stainless steel. The gambrel may be manufactured using any suitable process, for example using a punch and die or a laser machining process.

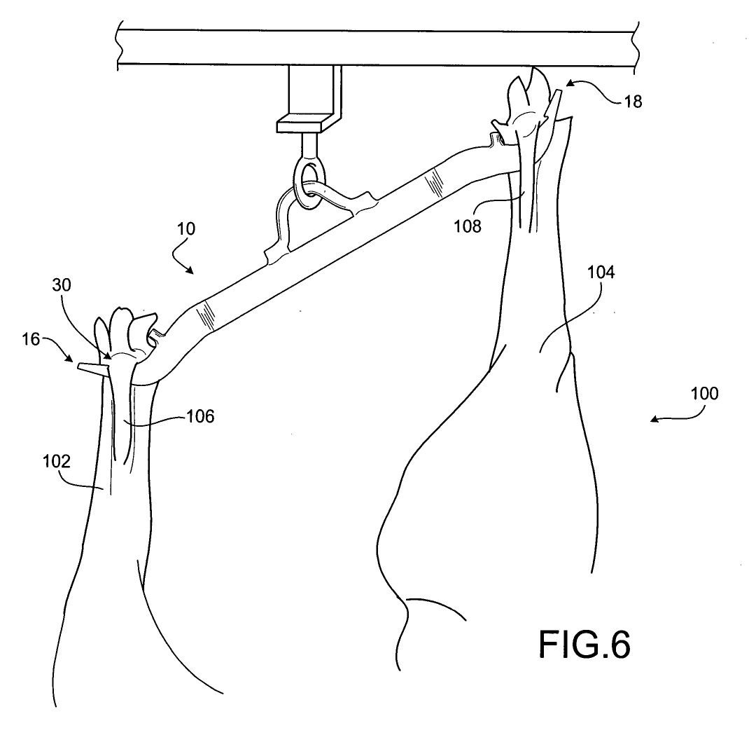

Referring now to FIG. 6, a hog carcass 100 is suspended from the gambrel 10 by its hind legs 102, 104 in the lower region of each leg. An incision is made in each lower leg, so that each end 16, 18 of the gambrel can be inserted between the tendons 106, 108 and the remainder of the leg. The gambrel will be in balance as long as the weight of the carcass is relatively evenly distributed between the legs, for example when the carcass has not been fully split. In this state, the elongated member will be generally horizontal and the lower legs will rest in the curved areas 24, 26 of the elongated member 12. When the carcass becomes unbalanced, for example if it is inadvertently split down its entire length, the gambrel will tilt, causing the legs to slip out of the curved portions. However, rather than slipping off of the ends, as the legs slide outward they will be caught by the notches 28, 30. Edge 32 will tend to engage the tendon, which will then be captured in the notch between wall 34 and wall 36. FIG. 6 illustrates tendon 106 of the leg on the left-hand side of the figure being captured in the notch 30 of the gambrel.

A number of embodiments of the invention have been described. Nevertheless, it will be understood that various modifications may be made without departing from the spirit and scope of the invention. Accordingly, other embodiments are within the scope of the following claims.

1. A gambrel for hanging an animal carcass, the gambrel comprising:
an elongated member having a first end, a second end, and a central region intermediate the ends,
between each end and the central region, a curved portion for receiving a leg of the animal carcass, and
adjacent each end, a retaining portion having an edge that engages the leg and prevents the leg from sliding off of the end when the elongated member is tilted from a horizontal position;
wherein each end has an upper surface and the retaining portion comprises a notch indented into the upper surface defining a hook, and the edge extends widthwise across the upper surface at an upper end of the notch.

2. (canceled)

3. (canceled)

4. The gambrel of claim 1 wherein the notch is sufficiently deep so as to receive a tendon of the animal carcass.

5. The gambrel of claim 1 wherein the elongated member is a single, unitary rigid member.

6. The gambrel of claim 1 wherein the elongated member is constructed to suspend a hog carcass.

7. The gambrel of claim 1 further comprising, adjacent an inner end of each curved portion, a protrusion that extends outwardly from the elongated member to prevent the leg from sliding into the central region when the elongated member is tilted from a horizontal position.

8. The gambrel of claim 1 wherein the ends are constructed to be inserted through an incision formed in the leg of the animal carcass.

9. The gambrel of claim 1 further comprising a hanger, extending upwardly from the elongated member, defining an opening shaped to allow the gambrel to be suspended and transferred along a production line.

10. The gambrel of claim 1 wherein the notch comprises first and second surfaces, disposed at an angle of about 30 to 50 degrees to each other.

11. The gambrel of claim 1 wherein the curved portion has a radius of curvature of from about 1.5 to 2.5 inches.

12. A gambrel for suspending an animal carcass, comprising
a support means, comprising a single, unitary elongated rigid member, for supporting the weight of the animal carcass, the support means including means for receiving first and second legs of the animal carcass,
a first means, comprising a first portion of the elongated rigid member, for preventing the first leg of the animal carcass from slipping from the support means when the support means is tilted; and
a second means, comprising a second portion of the elongated rigid member, for preventing the second leg of the animal carcass from slipping from the support means when the support means is tilted.

13. (canceled)

14. The gambrel of claim 12 wherein the means for receiving the first and second legs comprise curved regions of the elongated rigid member.

15. The gambrel of claim 12 wherein the first and second means comprise notches in the elongated rigid member.

16. A method of handling a hog carcass comprising
forming incisions in first and second hind legs of the hog carcass,
providing a gambrel comprising (a) an elongated member having a first end, a second end, and a central region intermediate the ends, (b) between each end and the central region, a curved portion for receiving a leg of the animal carcass, (c) adjacent each end, a retaining portion having an edge that engages the leg and prevents the leg from sliding off of the end when the elongated member is tilted from a horizontal position, each end having an upper surface and the retaining portion comprising a notch indented into the upper surface defining a hook, and the edge extending widthwise across the upper surface at an upper end of the notch, and (d) a hanger, adjacent the central region, for hanging the gambrel,
inserting the first and second ends of the gambrel into the incisions in the first and second hind legs of the hog carcass, and
hanging the gambrel, using the hanger, so that the hog carcass is suspended.

17. The method of claim 16 further comprising using the gambrel to transfer the hog carcass to a station on a meat processing line.

18. The method of claim 16 further comprising splitting the hog carcass along its length.

19. The method of claim 18 further comprising, if the hog carcass becomes unbalanced on the gambrel, causing the retaining portion to engage a tendon of the first or second hind leg.

20. (canceled)
